(19) United States
(12) Patent Application Publication
(10) Pub. No.: US 2023/0158825 A1
(43) Pub. Date: May 25, 2023

(54) ATTACHMENT SYSTEM, COMPONENTS THEREOF, AND METHOD FOR USING

(71) Applicant: ACCO Brands Corporation, Lake Zurich, IL (US)

(72) Inventors: Michael Rowe, Dayton, OH (US); Jeremy Mudd, Bellbrook, OH (US); Edward Busam, Mason, OH (US); Noah E. Dingler, Phoenixville, PA (US); Patrick Nolan, Royersford, PA (US); Andrew J. Miller, Phoenixville, PA (US); Nate Verso, Phoenixville, PA (US)

(21) Appl. No.: 17/530,840

(22) Filed: Nov. 19, 2021

(51) Int. Cl. B42F 9/00; B42D 1/00

(52) U.S. Cl. CPC B42F 9/00; B42D 1/007

(57) ABSTRACT

Attachment systems, components, and methods are described herein that use a combination of attachment, anchor, or retention mechanisms to secure components to one another. By one approach, a combination of flap, swing clip, and notch features incorporated into one or more devices to provide the ability to attach or combine devices of multiple formats. In some configurations, the attachment systems include a device with at least one panel having a flap and a swing clip on a free edge thereof. The attachment systems also may include at least one attachable device having at least one panel with a notch formed on a free edge thereof. The attachable devices may be attached to each other in a configuration where the notch is aligned with the flap and the swing clip is in a closed position such that the notch and the flap are nested within the swing clip.

### TECHNICAL FIELD

This disclosure relates generally to a system and method for attaching one or more devices together, in particular, to attaching one or more school and/or office supplies together.

### BACKGROUND

School and office supplies and accessories are available in a number of formats, including folders, notebooks, binders, filers, filler paper, and storage pouches. The various formats may have different sizes and functionalities. Students continue to desire additional storage space and the flexibility to carry multiple devices of different formats and to have all materials with them over the course of a busy day. Existing devices, however, may not provide the ability and flexibility to attach and combine multiple formats.

### BRIEF DESCRIPTION OF THE DRAWINGS

FIG. 1 is a top perspective view of an attachable notebook including a swing clip, in accordance with some embodiments;

FIG. 2 is a top plan view of the attachable notebook of FIG. 1, showing the swing clip in a closed position;

FIG. 3 is a top plan view of the attachable notebook of FIG. 1, showing the swing clip in an open position;

FIG. 4 is a bottom plan view of the attachable notebook of FIG. 1, showing the swing clip in a closed position;

FIG. 5 is a bottom plan view of the attachable notebook of FIG. 1, showing the swing clip in an open position;

FIG. 6 is a top perspective view of an attachable folder, including a swing clip;

FIG. 7 is a top plan view of the attachable folder of FIG. 6, showing the swing clip in a closed position;

FIG. 8 is a top plan view of the attachable folder of FIG. 6, showing the swing clip in an open position;

FIG. 9 is a bottom plan view of the attachable folder of FIG. 6, showing the swing clip in a closed position;

FIG. 10 is a bottom plan view of the attachable folder of FIG. 6, showing the swing clip in an open position;

FIG. 11 is a top perspective view of an attachable binder including a swing clip, in accordance with some embodiments;

FIG. 12 is a top plan view of the attachable binder of FIG. 11, showing the swing clip in a closed position;

FIG. 13 is a top plan view of the attachable binder of FIG. 11, showing the swing clip in an open position;

FIG. 14 is a bottom plan view of the attachable binder of FIG. 11, showing the swing clip in a closed position;

FIG. 15 is a bottom plan view of the attachable binder of FIG. 11, showing the swing clip in an open position;

FIG. 16 is a top perspective view of an attachable pouch including a swing clip, in accordance with some embodiments;

FIG. 17 is a top plan view of the attachable pouch of FIG. 16, showing the swing clip in a closed position;

FIG. 18 is a top plan view of the attachable pouch of FIG. 16, showing the swing clip in an open position;

FIG. 19 is a bottom plan view of the attachable pouch of FIG. 16, showing the swing clip in a closed position;

FIG. 20 is a bottom plan view of the attachable pouch of FIG. 16, showing the swing clip in an open position;

FIG. 21 is a top perspective view of an attachable binder, in accordance with some embodiments;

FIG. 22 is a top perspective view of the attachable binder of FIG. 21, further including an attachable notebook coupled thereto;

FIG. 23 is a top perspective view of the attachable binder of FIG. 21, further including an attachable notebook coupled thereto;

FIG. 24 a top perspective view of the attachable binder of FIG. 21, further including an attachable notebook coupled thereto;

FIG. 25 is a top perspective view of the attachable binder of FIG. 21, further including an attachable notebook and an attachable pouch coupled thereto, in accordance with some embodiments.

FIG. 26 is a top perspective view of another embodiment of an attachable binder including snap features.

FIG. 27 is a bottom perspective view of the attachable binder of FIG. 26.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or operations may be described or depicted in a particular order of occurrence while those skilled in the art will understand that such specificity with respect to sequence is not intended to be limiting. Although the sheet of material shown in the drawings is primarily illustrated as a sheet of lined notebook paper, it should be understood that other types of paper or other mediums may also be scanned in the manner provided herein.

### DETAILED DESCRIPTION

Generally speaking, attachment systems, devices, and methods are provided herein useful for attaching or combining devices, such as school and/or office supplies, of different formats. The attachment systems, devices, and methods use a combination of attachment, anchor, or retention mechanisms to secure components to one another. For example, the systems, devices, and methods may employ a combination of flap(s), swing clip(s), snap(s), and notch feature(s) incorporated into one or more devices to provide the ability and flexibility to attach or combine devices of multiple formats. It is also contemplated that other mechanisms such as snaps, hooks and loops, bungee cords, and the like or combinations thereof may be employed to secure components to one another. The attachment systems described herein include at least one attachable device that includes at least one panel having a flap and a swing clip on a free edge thereof. The swing clip is moveable between a closed position where the swing clip engages the flap and an open position wherein the swing clip does not engage the flap. By some approaches, the attachment systems described herein include at least one attachable device having at least one panel with a notch formed on a free edge thereof. The attachable devices may be attached to each other in a configuration where the notch is aligned with the flap and the swing clip is in a closed position such that the notch and the flap are nested within the swing clip.

When devices or components are connected-together in series or in a connected, attached, or partially nested configuration using the attachment systems, devices, and methods described herein, the devices may be fully functional and accessible. Fully functional as used herein means that a user is able to access contents of the device and use the device for its intended purpose. In one example, a notebook may be fully functional when a user is able to access and write on pages of the notebook. In another example, a folder may be fully functional when a user is able to access internal pockets on one or more panels of the folder. In yet another example, a binder may be fully functional when a user is able to access internal pockets, to access a binding mechanism (e.g., to add or remove pages from the binding mechanism) on in interior of the binder, and/or to write on one or more pages coupled to the binding mechanism. Further, a pouch may be fully functional when a user is able to access the contents of at least one storage compartment of the pouch.

In some embodiments, an attachment system comprises a first component and a second component. The first component comprises a first panel that includes at least one free edge having a flap that defines a flap opening between the flap and the first panel. A swing clip is coupled to the first panel adjacent to the flap, the swing clip being moveable between a closed position wherein the swing clip engages the flap and an open position wherein the swing clip does not engage the flap. The second component comprises a second panel having at least one free edge with a notch formed therein. The second component is attachable to the first component in a first configuration wherein the free edge of the second panel is positioned within the flap opening such that the notch is aligned with the flap opening and wherein the swing clip is in the closed position such that the notch and the flap are nested within the swing clip.

In some embodiments, an attachment system, comprises a first component and a second component. The first component comprises a first front panel that includes at least one free edge having a first flap that defines a first flap opening between the first flap and the first front panel. A first swing clip is coupled to the first front panel adjacent to the first flap, the first swing clip being moveable between a closed position wherein the swing clip swing clip engages the flap and an open position wherein the swing clip does not engage the flap. The first component further comprises a first back panel that includes at least one free edge with a first notch formed therein. The second component comprises a second front panel that includes at least one free edge having a second flap that defines a second flap opening between the second flap and the second front panel. A second swing clip is coupled to the second front panel adjacent to the second flap, the second swing clip being moveable between a closed position wherein swing clip engages the flap and an open position wherein the swing clip does not engage the flap. The second component further comprises a second back panel including at least one free edge with second notch formed therein. The second component is attachable to the first component in a first configuration wherein the at least one free edge of the second back panel is positioned within the first flap opening such that the second notch is aligned with the first flap opening and wherein the first swing clip is in the closed position such that the notch and the first flap are nested within the first swing clip.

In some embodiments, a method of attaching at least two components together is provided. At least one component comprises a clip panel including at least one free edge, the free edge having a swing clip coupled thereto and a flap folded over the clip panel. The swing clip is moveable between a closed position wherein the swing clip engages the flap and an open position wherein the swing clip does not engage the flap. Additionally, at least one component comprises a notch panel having at least one free edge with a notch formed therein. The method comprises inserting the notch panel under the flap of the clip panel such that the notch is aligned with the flap. The method further includes moving the swing clip to the closed position such that the flap and at least a portion of the notch panel are nested within the swing clip.

In some embodiments, an attachment system includes at least one component. The at least one component comprises a first panel that includes a first free edge, a second free edge, a third free edge, and a secured edge. The first free edge is opposite the third free edge. The second free edge is opposite the secured edge. A flap is disposed on the first free edge. The flap defines a flap opening between the flap and the first panel. A swing clip is coupled to the first panel along the first free edge adjacent to the flap. The swing clip is moveable between a closed position wherein the swing clip engages the flap and an open position wherein the swing clip does not engage the flap. At least one corner pocket is disposed at a corner of the first panel where the second free edge and the third free edge meet. The at least one component further comprises a second panel. The second panel includes at least one free edge with a notch formed therein. The notch is aligned with the swing clip and the flap on the first panel. A sheet of paper or another component is attachable to the front panel via the flap, the swing clip, and the at least one corner pocket.

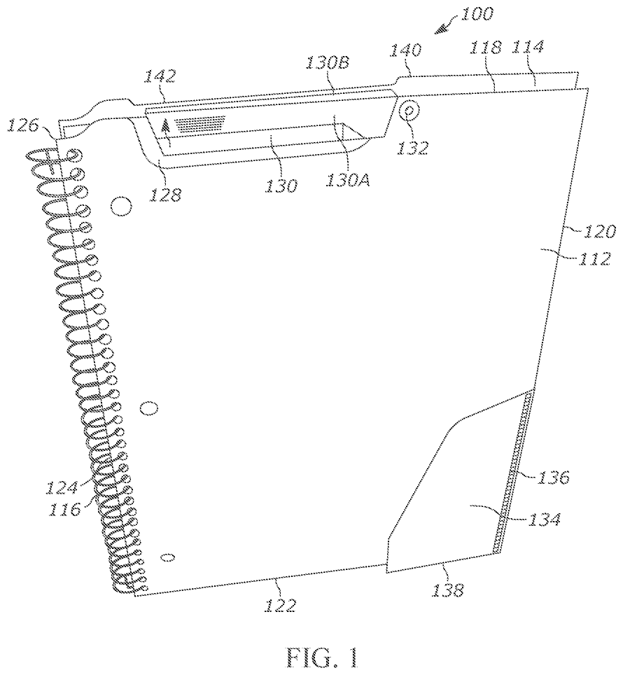

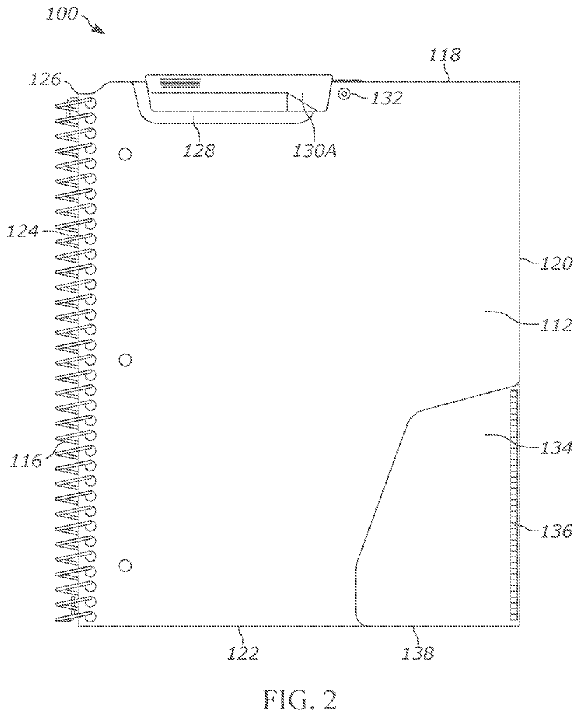

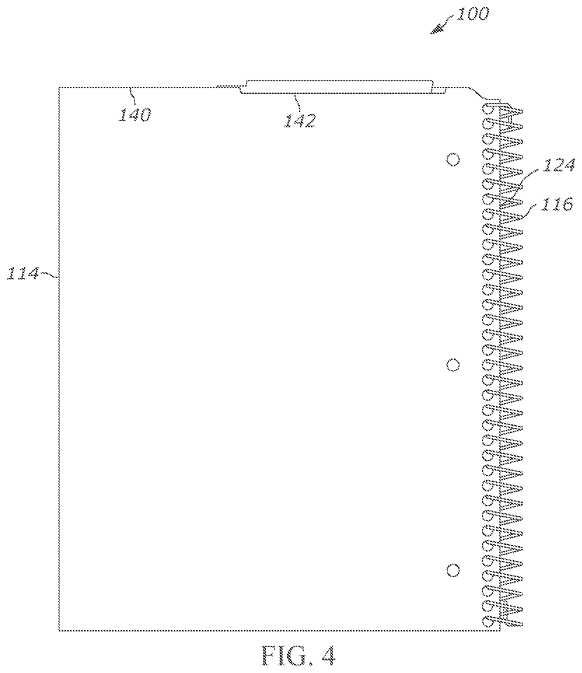

FIGS. 1-6 illustrate a first embodiment of an attachable device. The first embodiment is an attachable notebook 100. The attachable notebook 100 includes a front panel 112 and a rear panel 114. The front panel 112 and the rear panel 114 are coupled together along a hinged, folded edge or spine 116. The spine 116 may include a binding, such as, e.g., a wire binding, that holds the front panel 112 and the rear panel 114 together. In other configurations, the front panel 112 and rear panel 114 may be connected by a folded crease. As illustrated, one or more papers are coupled to the spine 116 and secured within the attachable notebook 100 between the front panel 112 and the rear panel 114.

The front panel 112 includes a first free edge 118, a second free edge 120, a third free edge 122, and a secured edge 124. The first free edge 118 is opposite the third free edge 122. The second free edge 120 is opposite the secured edge 124. In some aspects, the first free edge 118 is generally parallel to the third free edge 122 and the second free edge 120 is generally parallel to the secured edge 124. The first free edge 118 meets the secured edge 124 at a corner 126 of the front panel 112. The secured edge 124 is secured to the spine 116 of the attachable notebook 100.

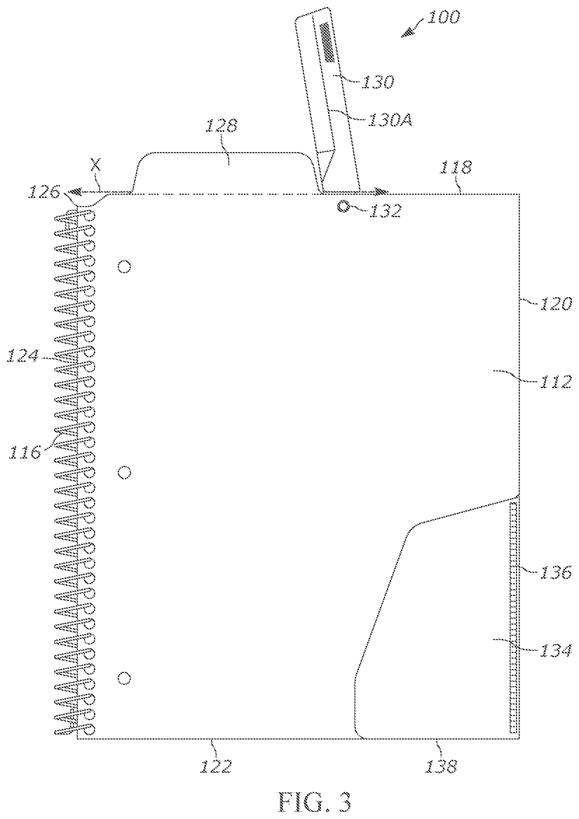

In some embodiments, the front panel 112 also includes a flap 128. By some approaches, the flap 128 is coupled to the first free edge 118 of the front panel 112. The flap 128, as shown, is positioned adjacent to the corner 126 at which the first free edge 118 and the secured edge 124 meet. In some aspects, the flap 128 may be generally rectangular in shape, though other shapes may be employed. The flap 128 is folded along a fold line X that is aligned with the first free edge 118. In a folded configuration, the flap 128 is folded over an outer face of the front panel 112 (i.e., over a face of the front panel 112 on the exterior of the attachable notebook 100). However, it is also contemplated that the flap 128 may be folded over an inner face of the front panel 112 (i.e., over a face of the front panel 112 facing the interior of the attachable notebook 100). In some aspects, the flap 128 is integral with the front panel 112 (see FIG. 3). In other aspects, the flap 128 may be connected to the front panel 112 via any suitable means, for example, by welding, sewing, stitching, staples, heat sealing, adhesive, mechanical fasteners, or the like.

In some embodiments, the flap 128 may have a length between about 1 in. and about 6. in, between about 2 in. and about 5 in., and, in some aspects, between about 3 in. and about 5 in. Further, in some embodiments, the flap 128 may have a height between about 0.1 in. and about 4 in. and, in some aspects, between about 0.4 in. and about 2 in. It is also contemplated that the width of the flap 128 may be greater than the width of the swing clip 130 such that the flap 128 overhangs the swing clip 130 when the swing clip 130 engages the flap 128.

The front panel 112 also includes a swing clip 130. It is contemplated that the swing clip 130 may be any form of clip or closure. For example, the swing clip 130 may be any rotatable or hinge clip. The swing clip 130 includes a first jaw portion 130A and a second jaw portion 130B. The swing clip 130 may be any suitable shape and, in some aspects, the bottom and side edges of the swing clip 130 (e.g., the bottom and side edges of the first jaw portion 130A) may be angled such that they correspond to the angles of the flap 128. The swing clip 130 is coupled to the front panel 112 along the first free edge 118 and adjacent to the flap 128. Any suitable rotatable attachment means 132 that allows the swing clip 130 to pivot, such as a rivet or a screw and nut, may be used to couple the swing clip 130 to the front panel 112. In some approaches, the swing clip 130 may also be heat-staked to the front panel 112. The swing clip 130 and the flap 128 are arranged such that the swing clip 130 may receive the flap 128 and fasten the flap 128 between the first jaw portion 130A and the second jaw portion 130B. The swing clip 130 is rotatably coupled to the front panel 112. The swing clip 130 is moveable between an open position and a closed position.

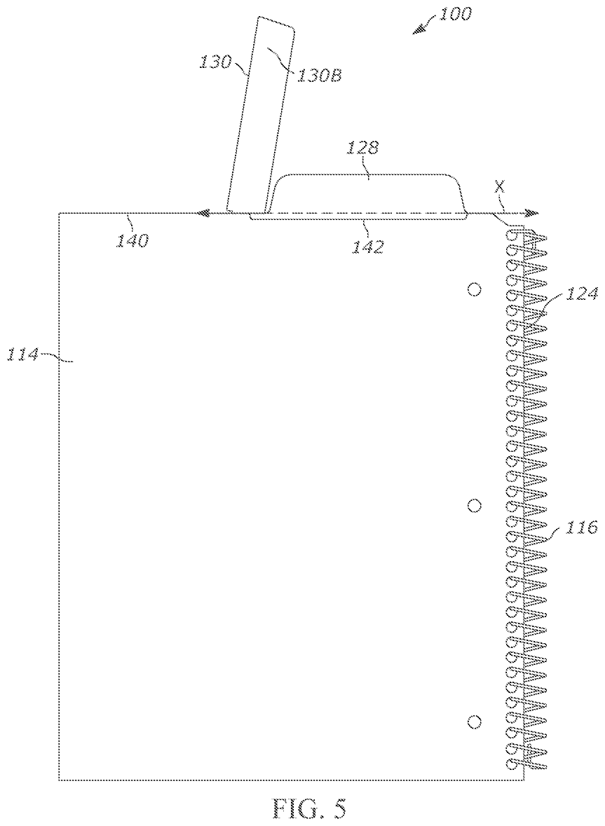

As shown in FIGS. 3 and 5, the swing clip 130 is in the open position. When the swing clip 130 is in the open position, the swing clip 130 is not aligned with the first free edge 118. In the open position, the first jaw portion 130A and the second jaw portion 130B do not engage the flap 128 and, consequently, a sheet of paper, a panel of a device, or a portion thereof may be easily inserted or removed from a space between the front panel 112 and the flap 128.

As shown in FIGS. 1, 2, and 4, the swing clip 130 is in the closed position. When the swing clip 130 is in the closed position, the swing clip 130 is aligned with the first free edge 118. In the closed position, the first jaw portion 130A and the second jaw portion 130B engage the flap 128 and, consequently, a sheet of paper, a panel of a device, or a portion thereof are secured within a space between the front panel 112 and the flap 128.

The swing clip 130 may be made of any suitable material including plastic materials, metallic materials, or combinations thereof. By one approach, the swing clip 130 is molded, such as by injection molding. By another approach, the swing clip 130 may be cut or stamped and then bent or otherwise formed into its final configuration. The materials forming the swing clip 130 may be treated or coated (before or after formation of the swing clip 130) to provide antimicrobial properties or to improve ease or comfort gripping the swing clip 130. The swing clip 130 may further include one or more gripping structures, such as ridges, roughened areas of the materials, or contoured areas to improve the ease of gasping the swing clip 130 and to facilitate opening and closing the swing clip 130. In some examples, the swing clip 130 may include a rubber or other soft or high coefficient of friction material to improve the ease of grasping and operating the swing clip 130.

As shown in FIGS. 1-3, the front panel 112 further includes a pocket flap or panel 134 to form a retaining flap or pocket between the front panel 112 and the pocket panel 134. The pocket panel 134 is on the outside of the front panel 112, that is, a surface of the of the front panel 112 that is on an external surface of the attachable notebook 100. The pocket panel 134, in one illustrative embodiment, is positioned diagonal to, adjacent, or over the corner 126 of the front panel 112 such that the pocket panel has an edge that extends from one edge of the panel front panel 112 to another edge. The pocket panel 134 is coupled to the front panel 112 along a first side portion 136 of the pocket panel 134. The pocket panel 134 may be coupled to the front panel 112 using a wide variety of methods such as heat welding, sonic welding, stitching, adhesive, staples, rivets, or other mechanical fasteners. In particular, the pocket panel 134 is coupled to the second free edge 120 of the front panel 112. In this manner, the pocket panel 134 forms a pocket opening that is facing at least the spine 116 and the first free edge 118.

Further, in some configurations, the pocket panel 134 includes a second side portion 138 that is not coupled to the front panel 112 (though in other configurations the pocket panel 134 may be coupled or secured along two edges). By having the pocket panel 134 attach along a single edge, the pocket flap or panel 134 is free or unsecured to the front panel 112 along an edge of the pocket panel 134 opposite the swing clip 130. As a result, a sheet of paper or a device (or a panel thereof) that is longer than the attachable notebook 100 may be positioned within the pocket opening and secured to the swing clip 130. For example, the swing clip 130 may attach the top end of a device (or panel thereof) that is longer than the attachable notebook 100 to the front panel 112. When the top end of the device (or a panel thereof) is attached to the front panel 112 in this manner, the bottom end of the device (or a panel thereof) is able to overhang the attachable notebook 100 at a when positioned within the pocket opening, since the bottom edge of the pocket panel 134 is free. It is contemplated that a pocket configured in this fashion may be employed in any one of the devices described herein. In one approach, by having swing clip 130, a top flap 128, a corner pocket or flap 134, available to retain objects to the attachable notebook 100, several points of securement are employed. For example, one or more pieces of loose-leaf paper may be coupled to the attachable notebook 100 by the first flap 124, the second flap or pocket 134, and the swing clip 130.

As shown, the pocket panel 134 is smaller than the front panel 112. In some configurations, the pocket panel 134 may be about 1/10 the size of the front panel 112, up to about ¼ the size of the front panel 112, or even up to about ½ the size of the front panel 112. In yet other configurations the pocket panel 134 may be about between about ¾ the size of the front panel 112. The pocket panel 134 may be sized such that, when another item such as a panel of another device, is inserted into the pocket, the pocket panel 134 does not interfere with the function of the inserted item. For example, if an item that has a pocket is inserted into the pocket formed by the pocket panel 134, the pocket of the inserted item would still be accessible. In this manner, the pocket formed by the pocket panel 134 may be used to secure an item to the front panel 112 without interfering with the functionality of the item

The pocket panel 134 may be made of any suitable materials, including but not limited to plastics (such as polypropylene or vinyl), cardboard, fabric, paper, paperboard, plastic encased cardboard, or any other planar rigid, semi-rigid, or flexible sheet material. In some aspects, the pocket panel 134 is formed from a material that is translucent or transparent such that the contents of the pocket are at least partially visible through the pocket panel 134.

The rear panel 114 includes a first free edge 140. In some aspects, the first free edge 140 of the rear panel 114 is aligned with the first free edge 140 of the front panel 112. The first free edge 140 includes a notch 142 formed therein. The notch 142 is positioned relative to the flap 128 and the swing clip 130 on the front panel 112. In some approaches, the notch 142 in the first free edge 140 of the rear panel 114 is aligned with the flap 128 on the first free edge 118 of the front panel 112. In some aspects, the notch 142 begins at a position on the rear panel 114 that corresponds to the position of rotatable attachment means 132 on the front panel 112. The notch 142 may allow two items of the same or about the same height to be coupled to each other without panels of the devices bulging or bubbling-up. The notch 142 is spaced from the second free edge 120. A distance between the second free edge 120 and the beginning of the notch 142 may be adjusted, for example, to accommodate attaching devices of different widths to each other. In some embodiments, the notch 142 may have a length between about 1 in. and about 6. in, between about 2 in. and about 5 in., and, in some aspects, between about 3 in. and about 5 in. Further, in some embodiments, the notch 142 may have a depth between about 0.01 in. and about 1 in. and, in some aspects, between about 0.1 in. and about 0.5 in.

In some aspects, the front panel 112 and/or the rear panel 114 may include pre-punched holes, for example, for engaging the rings of a binder. The pre-punched holes may be circular, “D”-shaped, or, in some approaches, generally triangular in shape.

The front panel 112 and the rear panel 114 of the attachable notebook 100 may be about the same size (though, in some configurations, there may be some difference or variation between the front and rear panel). The front panel 112 and/or the rear panel 114 may have a height of between about 8 in. and about 14 in., between about 9 in. and about 13 in., and, in some aspects, between about 10 in. and about 12 in. The front panel 112 and/or the rear panel 114 may have a width between about 5.5 in. and about 11.5 in., between about 6.5 in. and about 10.5 in., and, in some aspects, between about 8.5 in. and about 9.5 in.

The front panel 112 and/or the rear panel 114 may be made of any suitable materials, including but not limited to plastics (such as polypropylene or vinyl), cardboard, paperboard, plastic encased cardboard, fabric, paper, or any other planar rigid, semi-rigid, or flexible sheet material. In some aspects, the front panel 112 and/or the rear panel 114 may be made of material that is sufficiently stiff and/or rigid to support a stack of devices such, as several pounds, thereon without significant deformation. In other aspects, the front panel 112 and/or the rear panel 114 are formed from a material that is translucent or transparent such that the contents of the attachable notebook 100 are at least partially visible through the pocket panel 134. The materials may be treated or coated based on manufacturing and/or user preferences. For example, the materials may be treated or coated to provide antimicrobial or anti-slip properties, to improve durability, or to resist liquids such as water or ink. In some examples, the front panel 112 and/or the rear panel 114 may include a rubber or other soft or high coefficient of friction material to allow the panels or portions thereof to grip to a surface or minimize slipping. It is to be understood that the front panel 112 and the rear panel 114 may be comprised of the same or different materials.

Although FIGS. 1-5, depict the flap 128 and the swing clip 130 on the first free edge 118 of the front panel 112 and the notch 142 at the first free edge 140 of the rear panel 114 (e.g., at a top of the attachable notebook 100). It is contemplated that the flap 128, the swing clip 130, and the notch 142 may be coupled to any free edges of the attachable notebook 100 and along any position on such free edges, for example, as long as the notch 142 is aligned with the flap 128.

In operation, the swing clip 130 may be easily moved between the open position (see FIGS. 3 and 5) and the closed position (see FIGS. 1, 2, and 4). In the open position, one or more sheets of paper or portions of the devices described herein may be inserted under the flap 128. For example, a sheet of paper or panel of one or more of the devices described herein may be positioned under the flap 128 in a space between the flap 128 and the front panel 112. In the closed position, the flap 128 is tucked under the swing clip 130 and the swing clip 130 engages the flap 128 to grip or apply pressure to the outside of the flap 128. In this manner, the first jaw portion 130A and the second jaw portion 130B of the swing clip 130 may secure a sheet of paper or panel of a device in the space between the flap 128 and the front panel 112.

The flap 128 and the swing clip 130 also may be used to attach one or more sheets of paper to the attachable notebook 100. Additionally, the flap 128 and the swing clip 130 may be used to couple or attach another device (or a portion thereof), such as the other attachable devices described herein, or a panel thereof to the attachable notebook 100. It is also contemplated that the notch 142 may be used to attach the attachable notebook 100 to one or more of the other attachable devices described herein (e.g., the attachable folder 200, the attachable binder 300, the attachable pouch 400), as will be discussed further below. For example, the notch 142 may be positioned under the flap of another attachable device and the swing clip of another attachable device may secure the rear panel 114 of the attachable notebook 100 to the other attachable device. Thus, the flap 128, the swing clip 130, and the notch 142 provide the flexibility to both configure the attachable notebook 100 with other devices or supplies in a number of ways.

In some approaches, the pocket panel 134 may also operate to secure a piece of paper or a panel of a device to the attachable notebook 100. For example, when a piece of paper or a panel of a device is held on the front panel 112 by the flap 128 and the swing clip 130, the piece of paper or panel of a device may also be inserted into the pocket opening. In this manner, the pocket panel 134 acts to further hold or secure the piece of paper or panel of a device to the attachable notebook 100. Accordingly, the pocket panel 134 may offer additional stability and securement when multiple devices are attached to each other.

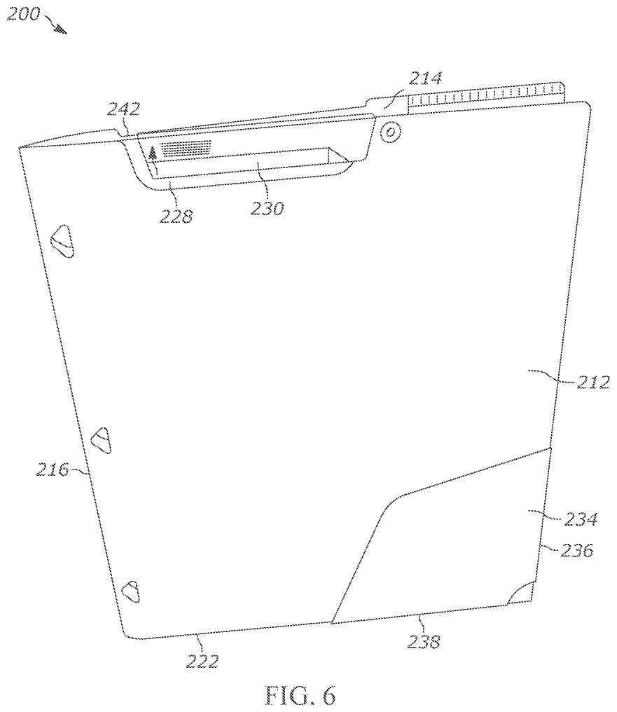

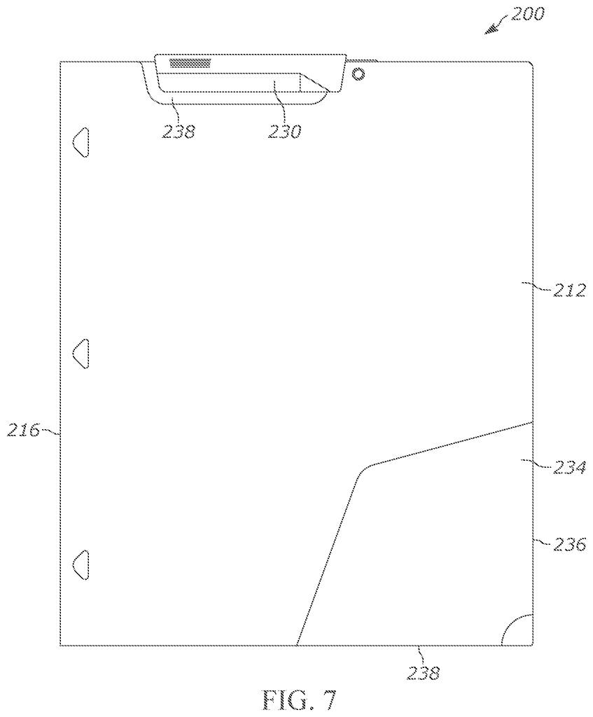

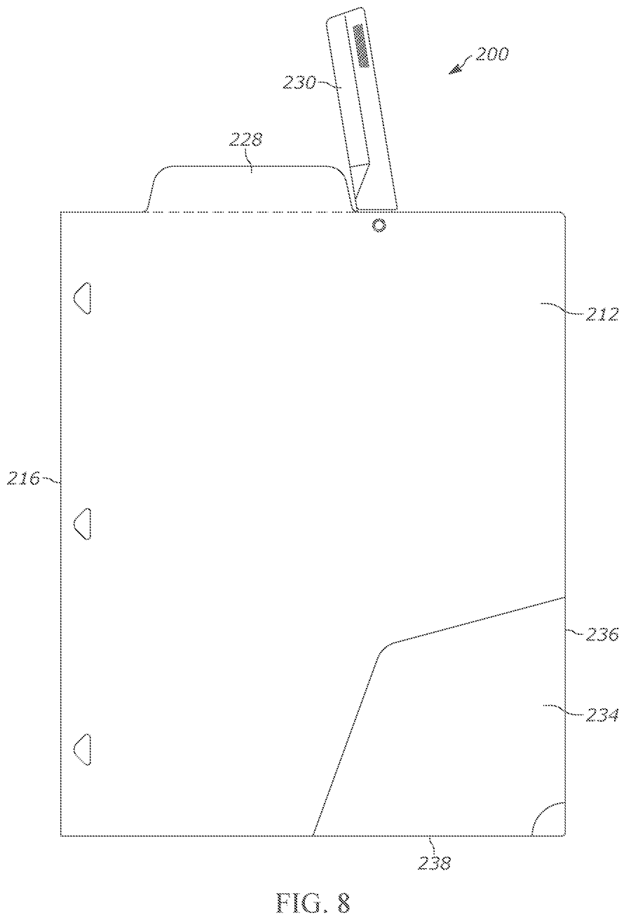

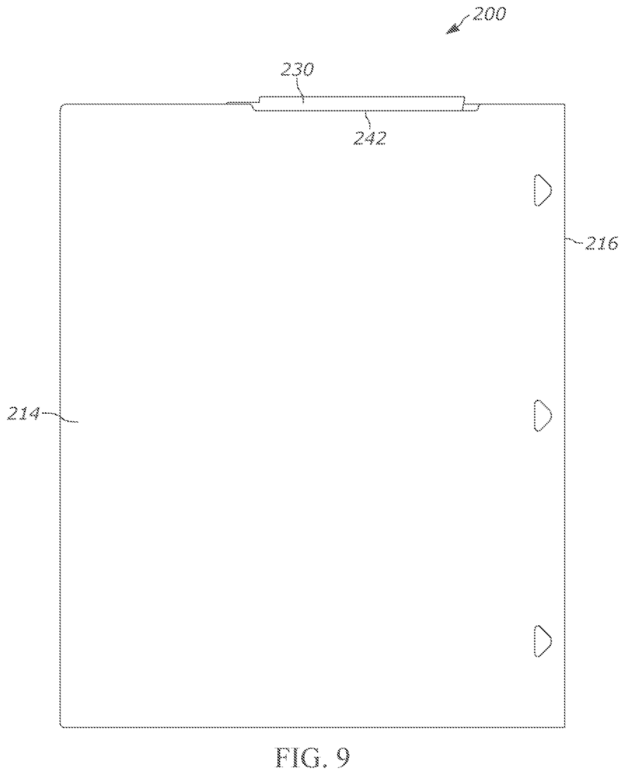

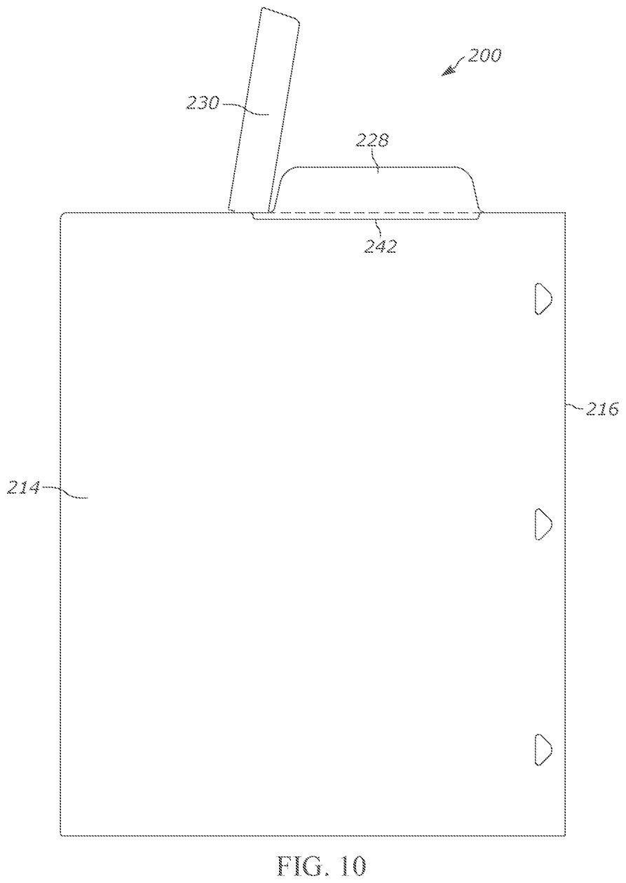

FIGS. 6-10 illustrate a second embodiment of an attachable device. In the second embodiment, the attachable device is an attachable folder 200. Elements in the second embodiment that are similar to those in the first embodiment have been given similar reference numbers in the two-hundred series and only the general differences will be discussed below. For example, the swing clip 130 described in the first embodiment is numbered as swing clip 230 in the second embodiment. The attachable folder 200 includes a front panel 212 and a rear panel 214. The attachable folder 200 is similar in many respects to the attachable notebook 100 with a difference being the interior of the attachable folder 200 does not include sheets of paper secured between the front panel 212 and the rear panel 214 and, instead, includes one or more pockets for storage.

The front panel 212 includes a flap 228, a swing clip 230, and a pocket panel 234. In some configurations, the flap 228 is similar to the flap 128 in the first embodiment, and the swing clip 230 is similar to the swing clip 130 in the first embodiment. The pocket panel 234 is coupled to the front panel 212 along both a first side portion 236 and a second side portion 238. In particular, the first side portion 236 is secured to the front panel 212 at or adjacent to the second free edge 220. Additionally, the second side portion 238 is secured to the front panel 212 at or adjacent to the third free edge 222. In this manner, the pocket panel 234 forms a pocket opening that is secured long the second free edge 220 and the third free edge 222. It is contemplated that coupling the second side portion 238 to the third free edge 222 of the front panel 212 may prevent materials from falling out of the pocket opening as a user may generally orient the attachable notebook 100 such that the first free edge 118 above the third free edge 222.

The rear panel 214 includes a notch 242 formed therein. The notch 242 is similar to the notch 142 in the first embodiment. The rear panel 214 is couplable to the front panel 212 along the spine 216. In some aspects, the front panel 212 and the rear panel 214 may be formed by folding a single piece of material and, consequently, the spine 216 is formed along a fold line.

The front panel 212 and the rear panel 214 of the attachable folder 200 may be about the same size (though, in some configurations, there may be some difference or variation between the front and rear panel). The front panel 212 and/or the rear panel 214 may have a height of between about 8 in. and about 16 in., between about 9 in. and about 15 in., and, in some aspects, between about 11 in. and about 13 in. The front panel 212 and/or the rear panel 214 may have a width between about 6 in. and about 12 in., between about 7 in. and about 11 in., and, in some aspects, between about 9 in. and about 10 in. It is contemplated that the attachable folder 200 may be wider and/or longer than the attachable notebook 100.

Like the attachable notebook 100 in the first embodiment, the attachable folder 200 may be attached to and configured with other devices or supplies in a number of ways via the flap 228, the swing clip 230, and the notch 242. The pocket panel 234 may also be used, along with the flap 228 and the swing clip 230, to couple a device to the attachable folder 200. Further, the pocket panel 234 may also provide added retention, for example for sheets of paper, when the pocket panel 234 is not being used to attach devices together.

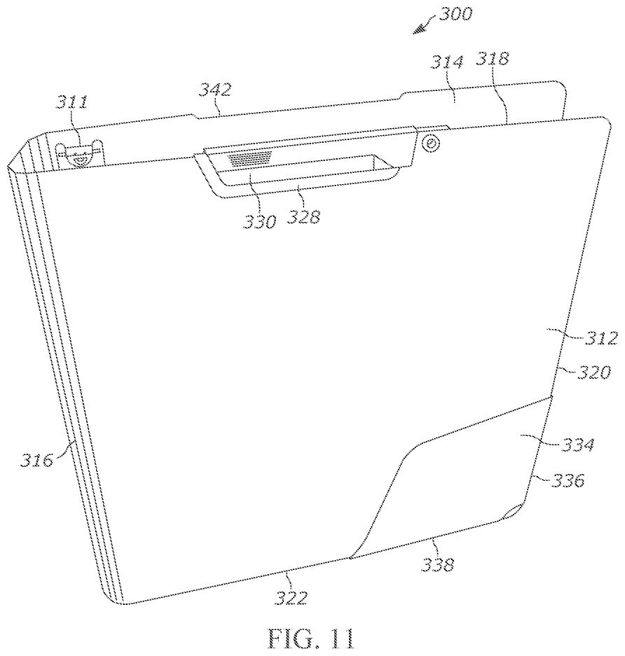

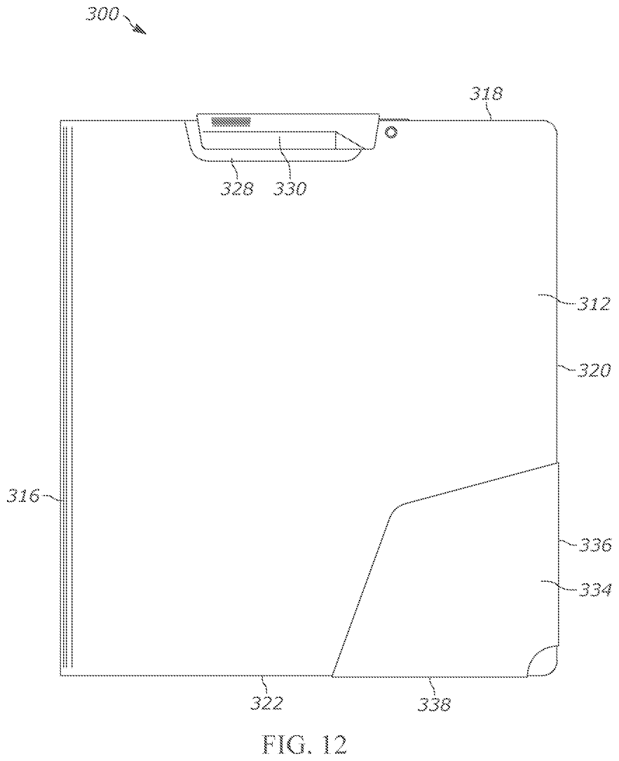

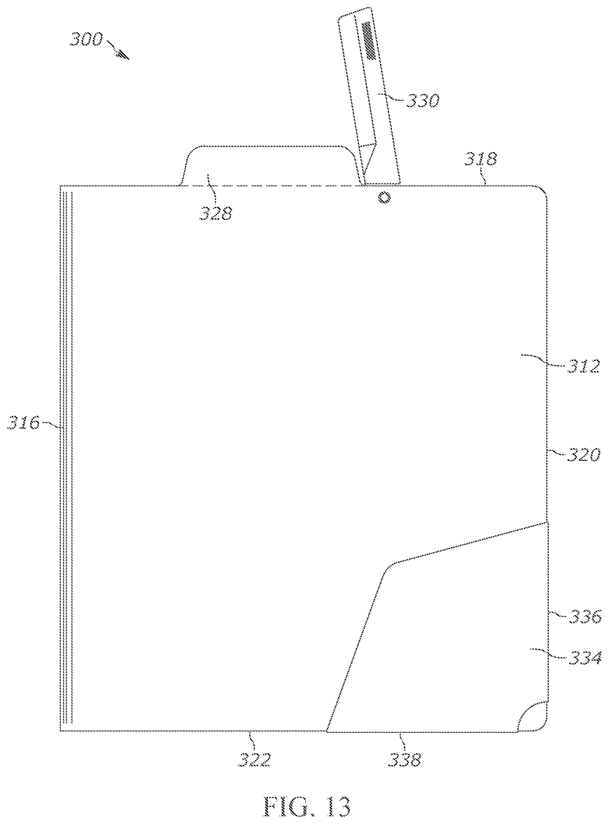

FIGS. 11-15 illustrate a third embodiment of an attachable device. In the third embodiment, the attachable device is an attachable binder 300. Elements in the third embodiment that are similar to those in the first embodiment have been given similar reference numbers in the three hundred series, and only the general differences will be discussed below. For example, the swing clip 130 described in the first embodiment is numbered as swing clip 330 in the second embodiment. The attachable binder 300 includes a front panel 312 and a rear panel 314. The attachable binder 300 is similar in many respects to the attachable notebook 100 of the first embodiment with a difference being the interior of the attachable binder 300 does not include sheets of paper secured in the spine 316 between the front panel 312 and the rear panel 314 and, instead, includes a binding mechanism 311 coupled to an interior surface of the attachable binder 300. In some aspects, the interior surface of the attachable binder 300 also includes one or more pockets, for example, to facilitate the storage of papers or other items therein.

The front panel 312 includes a flap 328, a swing clip 330, and a pocket panel 334. The flap 328 is similar to the flap 128 in the first embodiment. The swing clip 330 is similar to the swing clip 130 in the first embodiment. The pocket panel 334, however, may be similar to the pocket panel 224 described in the second embodiment or pocket flap or panel 134 from the first embodiment. As illustrated in FIG. 11, the pocket panel 334 is coupled to the front panel 312 along both a first side portion 336 and a second side portion 338. In some aspects, the pocket panels described herein 134, 234, 334 may include one or more cut-outs formed therein. Such cut-outs, for example, may reduce stresses on the pocket panel 134. For example, a corner of the front panel 312 may create stresses on a corner of the pocket panel, creating a point of wear. Positioning a cut-out at the corner of the pocket panel may eliminate this point of wear. In addition, cut-outs in the pocket panels 123, 234, 334 may accommodate a rounded corner of the front panel 312 and/or may reduce stresses at the corner of the front panel 312.

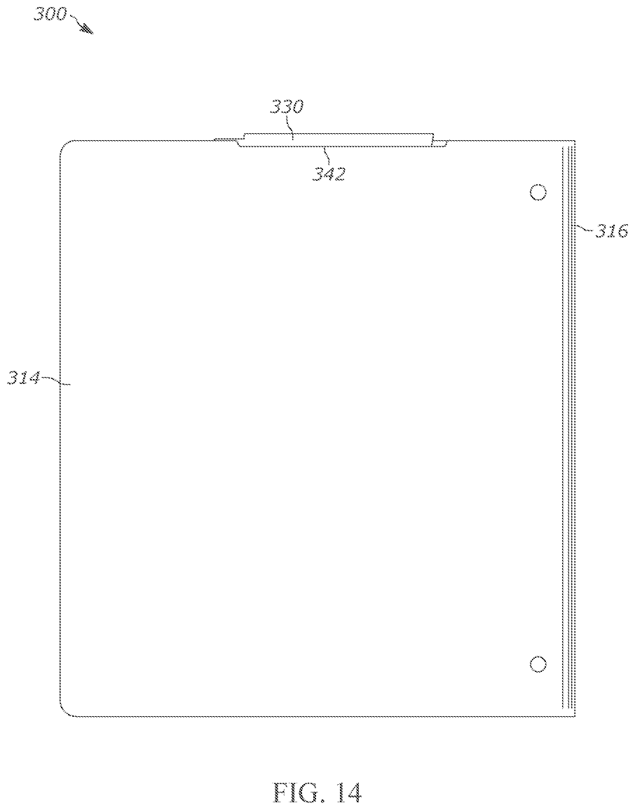

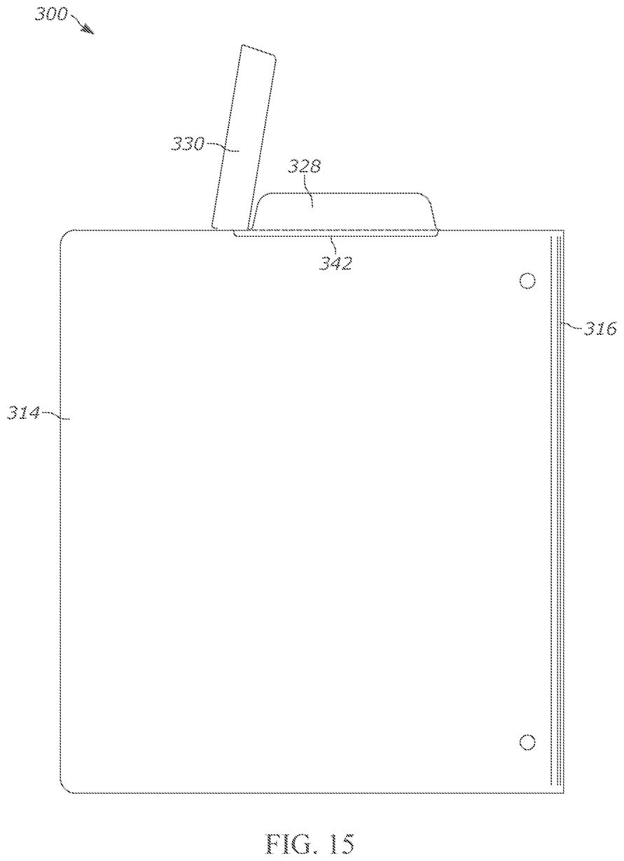

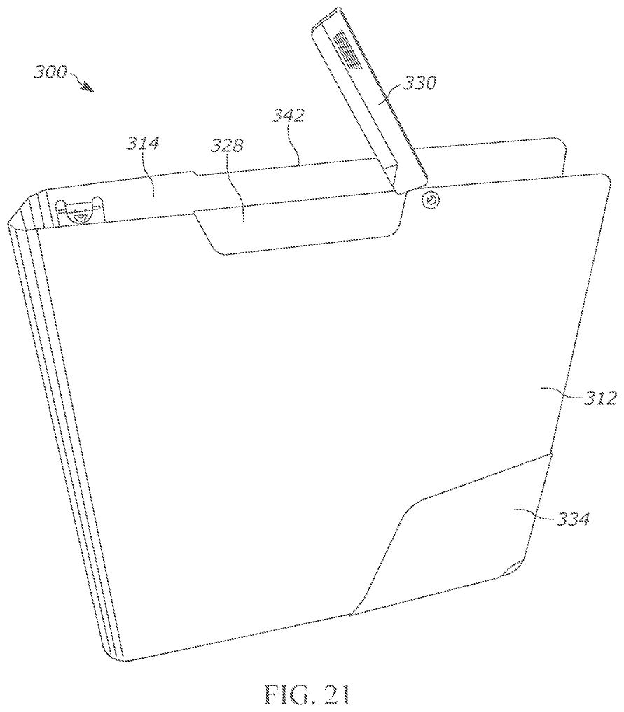

As shown in FIGS. 14 and 15 (and in FIG. 21), the rear panel 314 includes a notch 342 formed therein. The notch 342 is similar to previously described notches. The rear panel 314 is coupled to the front panel 312 along the spine 316. In some aspects, the front panel 312 and the rear panel 314 may be formed of single piece of material and, consequently, the spine 316 may be formed from a series of creases in the piece of material. In some configurations, the binding mechanism 311 is coupled to an interior surface of the rear panel 314, that is, a surface of the rear panel 314 facing the inside of the attachable binder 300. However, it is also contemplated that binding mechanism 311 may alternatively be coupled to an interior surface of the front panel 312 or the spine 316.

The front panel 312 and the rear panel 314 of the attachable binder 300 may be about the same size (though, in some configurations, there may be some difference or variation between the size and shape of the panels). The front panel 312 and/or the rear panel 314 may have a height of between about 8 in. and about 16 in., between about 9 in. and about 15 in., and, in some aspects, between about 11 in. and about 13 in. The front panel 312 and/or the rear panel 314 may have a width between about 6 in. and about 15 in., between about 8 in. and about 13 in., and, in some aspects, between about 9 in. and about 11 in. It is contemplated that the attachable binder 300 may be wider and/or longer than the attachable notebook 100.

Like the attachable notebook 100 in the first embodiment, the attachable binder 300 may be attached or configured with other devices or supplies in a number of ways via the flap 328, the swing clip 330, and the notch 342. The pocket panel 334 may also be used, along with the flap 328 and the swing clip 330, to couple a device to the attachable binder 300. Further, the pocket panel 334 may also provide added retention, for example for sheets of paper, when the pocket panel 334 is not being used to attach devices together.

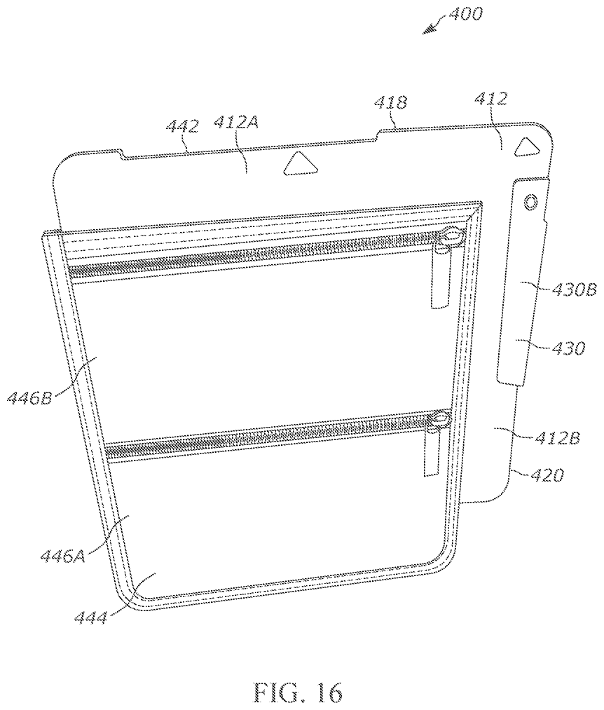

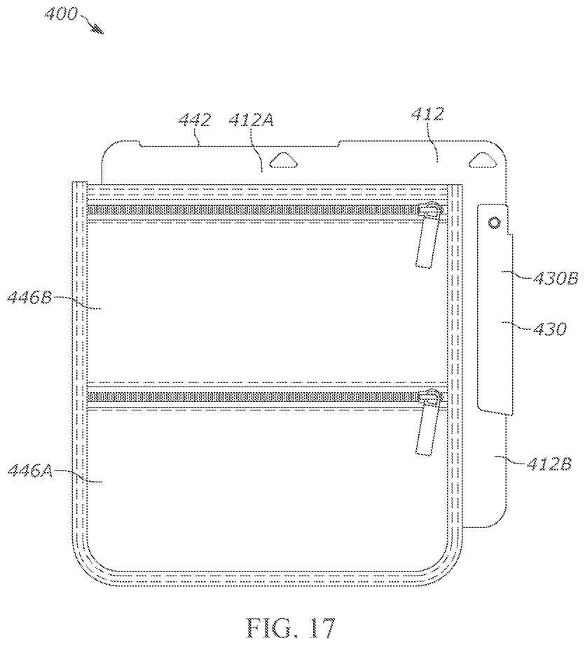

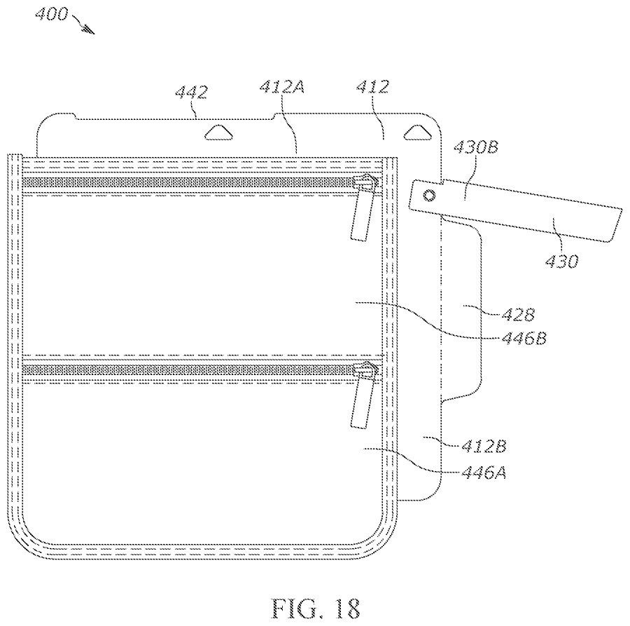

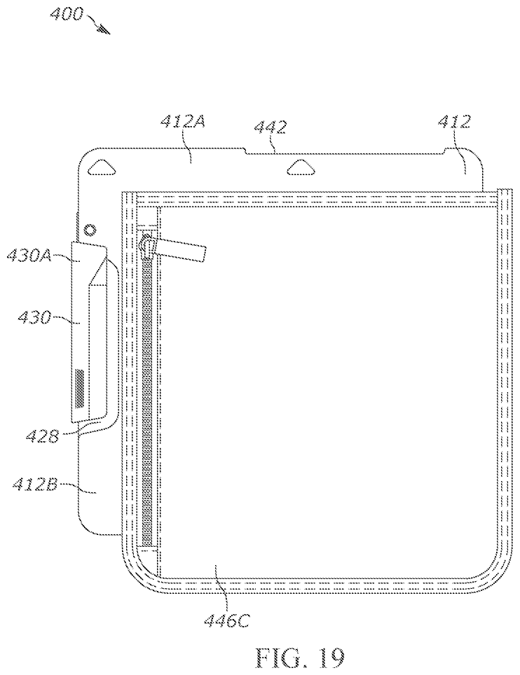

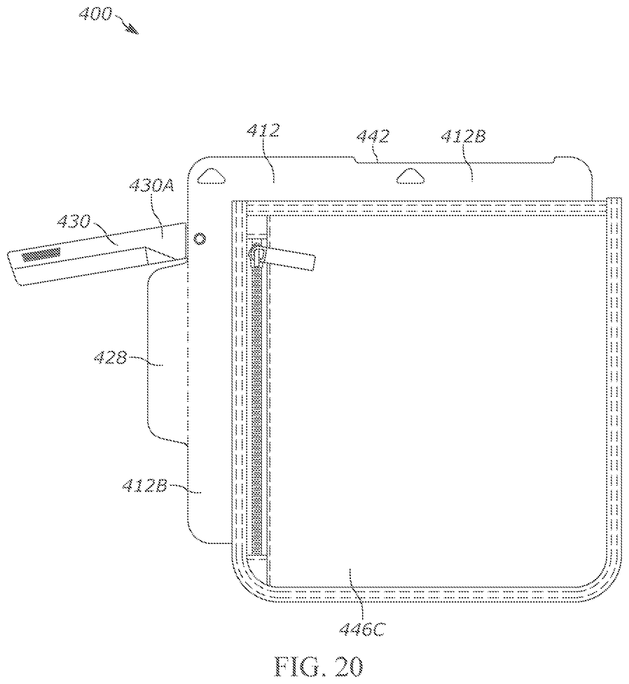

FIGS. 16-20 illustrate a fourth embodiment of an attachable device. In the fourth embodiment, the attachable device is an attachable pouch 400. Elements in the fourth embodiment that are similar to those in the first embodiment have been given a similar reference number in the four-hundred series, and only the general differences will be discussed below. For example, the swing clip 130 described in the first embodiment is numbered as swing clip 430 in the second embodiment, with a difference being that the swing clip 430 is positioned in a different orientation (i.e., with a first jaw portion 430A oriented towards a rear side of the panel 412 and a second jaw portion 430B oriented towards a front side of the panel 412). The attachable pouch 400 is similar in many respects to the attachable notebook 100 of the first embodiment, with a difference being that the attachable pouch 400 includes a single panel 412 having at least one storage pouch 444 coupled thereto or incorporated therewith.

In one illustrative approach, the panel 412 is generally “L”-shaped. The panel 412 comprises a first leg 412A and a second leg 412B. In some aspects, the first leg 412A is perpendicular to the second leg 412B. The first leg 412A includes a first peripheral edge 418. The first peripheral edge 418 includes a notch 442 formed therein. The notch 442 is similar to the notch 142 described in the first embodiment. The second leg 412B includes a second peripheral edge 420. The second peripheral edge 420 includes a flap 428 and a swing clip 430 coupled thereto. The flap 428 is similar to the flap 428 described in the first embodiment, a difference being that the flap 128 is folded towards a rear side of the panel 412 as opposed to a front side. The swing clip 430 is similar to the swing clip 130 described in the first embodiment.

By one approach, the storage pouch 444 is coupled to the panel 412 in a space between the first leg 412A and the second leg 412B. The storage pouch 444 be coupled to the panel 412 using a wide variety of methods such as heat welding, sonic welding, stitching, adhesive, staples, rivets, or other mechanical fasteners. The storage pouch 444 may include one or more compartments 446A, 446B, 446C accessible via openings. Openings of the compartments 446A, 446B, 446C may be releasably secured through the use of zippers, magnets, clasps, buttons, ties, magnets, snaps, hook and loop fasteners, resealable adhesives, or the like. It is also contemplated the openings of the compartments 446A, 446B, 446C may be configured in any suitable manner, for example, the openings may be parallel with the first leg 412A or the second leg 412 and, in some aspects, may even be oriented diagonally.

In some aspects, the panel 412 may include pre-punched holes, for example, for engaging the rings of a binder. The pre-punched holes may be circular, “D”-shaped, or, in some approaches, generally triangular in shape. It is to be understood that the pre-punched holes may be included on one or more of the first leg 412A and the second leg 412B. In some approaches, the pre-punched holes may be coupled to the first leg 412A, or the leg of the panel 412 that does not include the swing clip 430. In this manner, the swing clip 430 may be operated (e.g., moved between the open and closed positions) when the holes are coupled to a binding mechanism.

The configuration of the attachable pouch 400 provides several options for attachment with other devices. In one approach, the attachable pouch 400 may be coupled to another device via the flap 428 and the swing clip 430, for example, by securing a panel of the device within the flap 428 and the swing clip 430. In another approach, the attachable pouch 400 may be secured to a device having a binding mechanism, such the binding mechanism 311 in the attachable binder 300, via the pre-punched holes. In other embodiments, the notch 442 of attachable pouch 400 may be positioned under the flap of one of other attachable devices described herein such that the panel 412 may be secured to the other attachable device via its swing clip. Accordingly, the attachable pouch 400 provides the flexibility to attach or couple to a variety of devices using a variety of means.

Although the swing clips and flaps are included on the front panel and the notches are included on the rear panel in the attachable devices depicted in FIGS. 1-15, it is also contemplated that this orientation may be reversed. That is, the swing clips and flaps may be included on the rear panel and the notch may be included on the front panel.

FIGS. 21-25 illustrate the manner in which one of more of the devices described herein may be attached or otherwise coupled to each other using the swing clip, flap, and notch features described herein.

Turning to FIG. 21, the attachable binder 300 is illustrated with the swing clip 330 in the open position. The flap 328 is folded over towards the outer face of the front panel 312. The flap 328 is positioned in such a pre-folded configuration when the attachable binder 300 is assembled. When the attachable binder 300 is configured as shown in FIG. 21, a sheet of paper or panel of a device may be received under the flap 328.

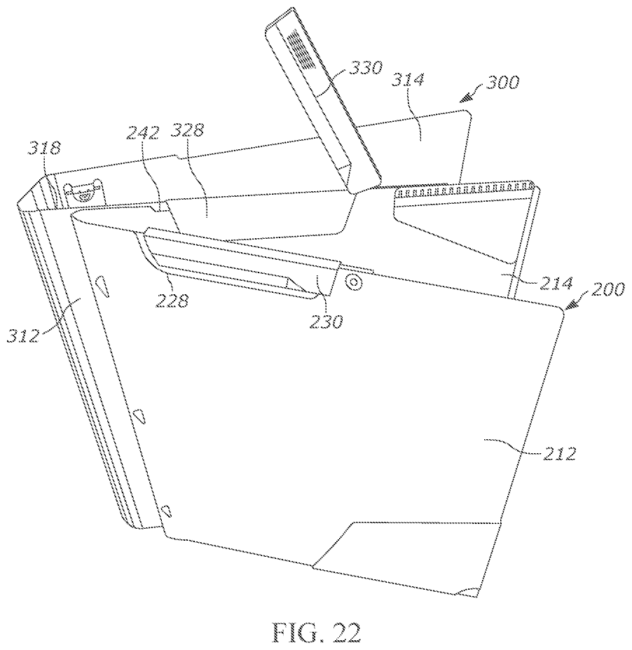

Turning to FIG. 22, the attachable folder 200 is coupled to the attachable binder 300. In particular, the rear panel 214 of the attachable folder 200 is disposed underneath the flap 328 of the front panel 312 of the attachable binder 300 such that the swing clip 330 may be rotated downward to couple the attachable folder 200 to the attachable binder 300. More particularly, a portion of the rear panel 214 is inserted under the flap 328 of the attachable binder 300 such that the notch 242 aligns the with flap 328, and the free edge of the rear panel 214 of the attachable folder 200 aligns with the first free edge 318 of front panel 312 of the attachable binder 300.

As illustrated in FIG. 22, the position of the notch 242 on the rear panel 214 of the attachable folder 200 and the position of the flap 328 and the swing clip 330 on the front panel 312 of the attachable binder 300 ensure proper alignment of the two devices when coupled together. That is, the notch 242, the flap 328, and the swing clip 330 are positioned such that the peripheral edges of the attachable folder 200 approximately align with the peripheral edges of the attachable binder 300 when the attachable folder 200 is coupled to the attachable binder 300. It is contemplated that the attachable devices described herein may have notches, flaps, and swing clips positioned in a complementary manner to ensure proper alignment of the devices when one or more devices are attached to each other.

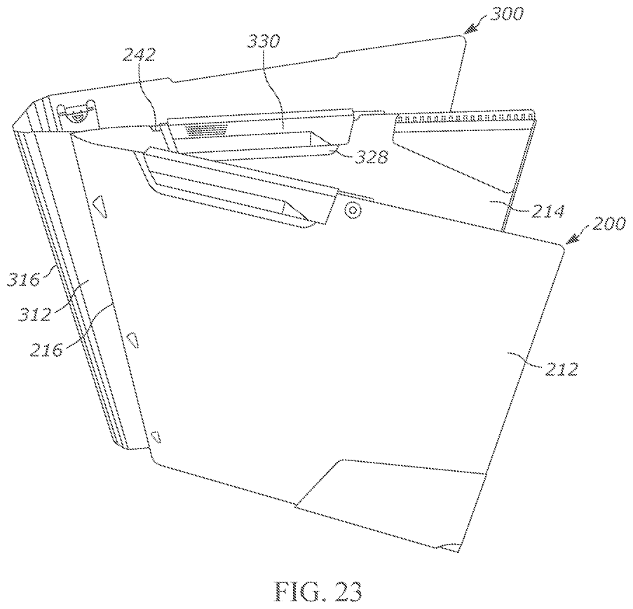

Turning to FIG. 23, the attachable folder 200 is illustrated as attached to the attachable binder 300. The swing clip 330 is in the closed position to attach the rear panel 214 of the attachable folder 200 to the front panel 312 of the attachable binder 300. Thus, the attachable folder 200 and the attachable binder 300 can be transported or stored together as a single unit. The flap 328, swing clip 330, and the notch 242 are configured where the notch 242 is aligned with the flap 328 and the swing clip 330 is in a closed position such that the notch 242 and the flap 328 (or portions thereof) are nested within the swing clip 330. It is contemplated that the notch 242 allows the top of the flap 328 to sit flush with the first free edge 318 of the front panel 312 when the flap 328 is nested within the swing clip 330. This may prevent, for example, the flap 328 from bulging out from the free edge 318 and may result in the swing clip 330 more securely engage the flap 328. Attaching one device to another in manner depicted in FIG. 23 may improve the convenience of handing or travelling with multiple devices, for example, by preventing slipping.

Further, when the attachable folder 200 and the attachable binder 300 are attached as shown in FIG. 23, the spine 216 of the attachable folder 200 and the spine 316 of the attachable binder 300 are aligned and, in some aspects, are approximately parallel. Additionally, the openings of the attachable folder 200 and the attachable binder 300 face the same direction such that the contents of the attachable folder 200 and the attachable binder 300 may be accessed from the same side when the two devices are attached to each other.

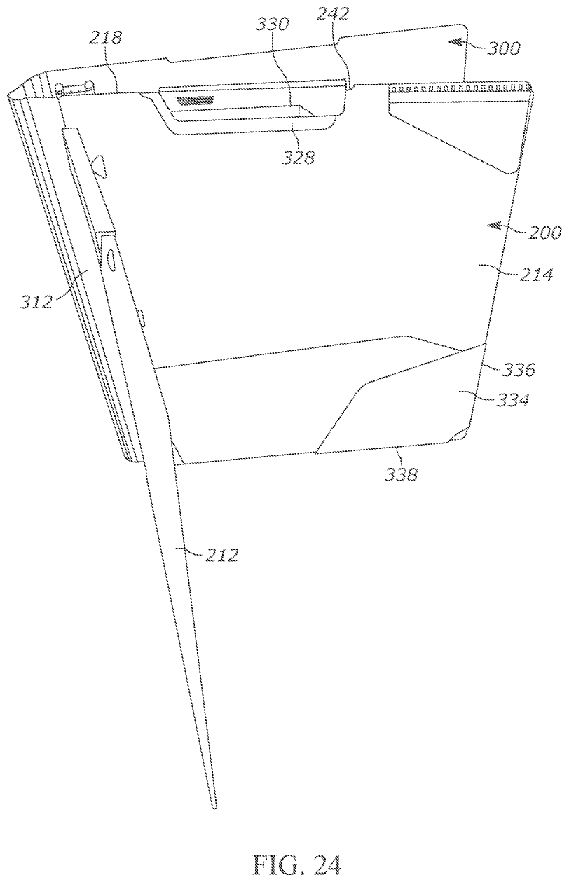

Turning to FIG. 24, the attachable folder 200 is attached to the attachable binder 300. The front panel 212 of the attachable folder 200 is depicted in an open position to show the interior of the attachable folder 200. In addition to being to the attachable binder 300 via the flap 328 and the swing clip 330, the attachable folder 200 is secured to the attachable binder 300 using the pocket panel 334. A corner of the rear panel 214 of the attachable folder 200 is positioned in the pocket opening formed by the pocket panel 334. Because the pocket panel 334 is secured to the front panel 312 along two sides 336, 338, the pocket panel 334 may prevent the rear panel 214 from slipping to the side or the bottom or from becoming dislodged from the swing clip 330.

As shown in FIG. 24, the notch 242 allows the attachable folder 200 and the attachable binder 300, which are the same or about the same height, to be coupled to each other without the rear panel 214 and/or the front panel 312 bulging or bubbling-up. For example, without the notch 242, the rear panel 214 may bulge when the rear panel 214 is partially nested within the flap 328/swing clip 330 and pocket panel 334. The notch 242 allows the first free edge 218 the rear panel 214 to be positioned slightly higher than front panel 312 to allow the rear panel 214 to nest within the flap 328/swing clip 330 and the pocket panel 334 without bulging.

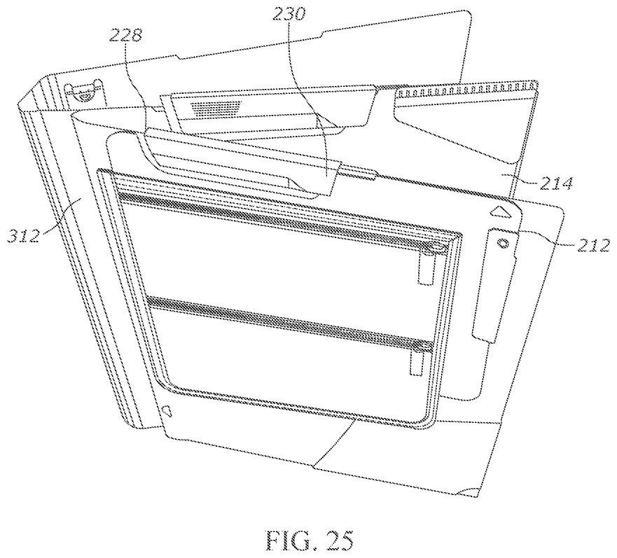

Turning to FIG. 25, the attachable folder 200 is attached to the attachable binder 300 and, additionally, the attachable pouch 400 is attached to the attachable folder 200. The attachable pouch 400 is attached to the attachable folder 200 via the flap 228 and the swing clip 230. In particular, the front panel 212 of the attachable folder 200 is coupled to the panel 412 of the attachable pouch 400. The notch 442 of the attachable pouch 400 is aligned with the flap 228, and the swing clip 230 is positioned around the flap 228 and the notch 442 to secure a portion the panel 412 within the jaws of the swing clip 230.

It is contemplated that any combination of the attachable devices described herein (i.e., the attachable notebook 100, the attachable folder 200, the attachable binder 300, the attachable pouch 400) may be attached together in a manner similar to that described with reference to FIGS. 21-25.

Further, it is contemplated that when the attachable devices described herein are attached together, for example, using the flaps, swing clips, notches, and/or pocket panels described herein, the internal features of the attachable devices are accessible and/or useable. Accordingly, in an attached or partially nested configuration, sheets of paper in a notebook or binder, a binding mechanism, and/or internal pockets on an internal portion of the devices may accessed or used. In this manner, the attachable devices are functional and useable when the attachable devices are attached or otherwise coupled together using the attachment systems, devices, and methods described herein.

In some embodiments, one or more snaps may be employed instead of one or more of the flap, swing clip, and notch features described herein. Snaps may be incorporated onto one or more devices (such as notebooks, folders, binders, and/or pouches) to allow the devices to be attached to each other in various configurations.

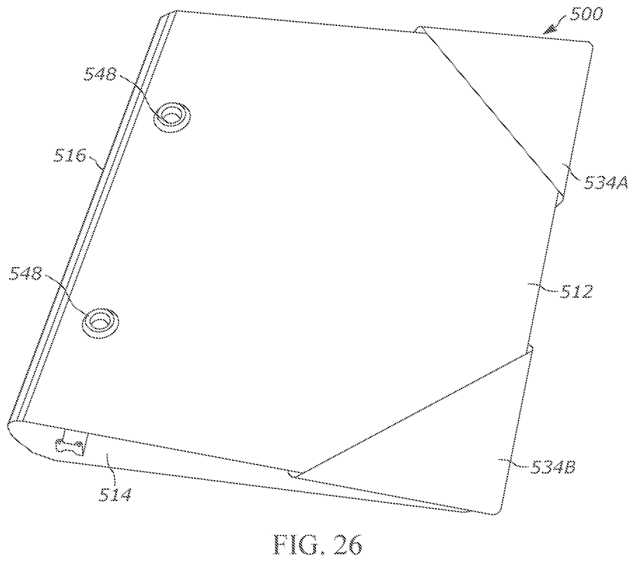

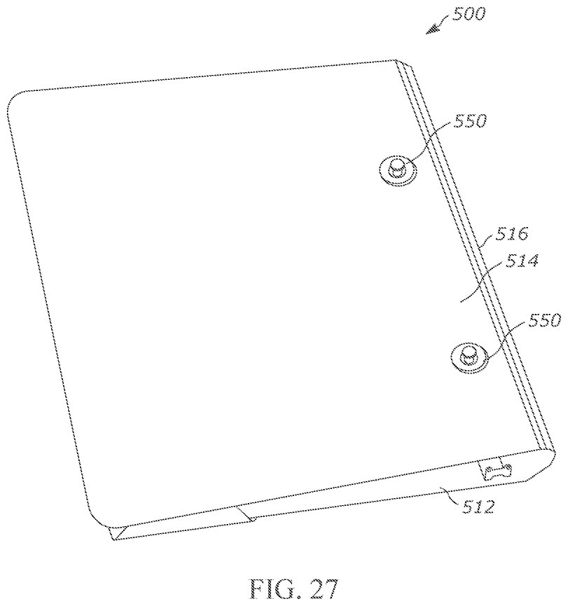

FIGS. 26-27 illustrate another embodiment of an attachable binder 500. The attachable binder 500 employs snap features such that the attachable binder 500 may be coupled other devices including complementary snap features. The attachable binder 500 includes a front panel 512, a rear panel 514, and a spine 516 coupling the front panel 512 to the rear panel 514. The front panel 512 includes one or more snap female snap components 548. The female snap components 548 at positioned adjacent to the spine 516 and the female snap components 548 are aligned with each other. In some aspects, the female snap components 548 are aligned in parallel with the spine 516. It is also contemplated that the female snap components may be positioned adjacent to and, in some aspects parallel to, one or more of the free edges of the front panel 512.

The front panel 512 further includes one or more pocket panels 534A, 534B positioned at the corners of the front panel 512. The pocket panels 534A, 524B are coupled to the corners of the front panel 512 opposite the spine 516. The pocket panels 534A, 534B form pocket openings between the pocket panels 534A, 534B and the front panel 512. It is contemplated that the pocket panels 534A, 534B and pocket openings may provide additional retention and/or attachment functionality for the attachable binder 500. For example, the pocket openings may receive a panel of a device (or portions thereof) to retain or otherwise attach the panel on the front panel 512 of the attachable binder 500. In another example, the pocket openings may receive one or more sheets of paper to retain or otherwise attach the sheets of paper on the front panel 512 of the attachable binder 500. In some embodiments, the pocket panels 534A, 534B and the female snap components 548 may be positioned on opposing sides or edges of the front panel 512.

The rear panel 514 includes one or more male snap components 550. The male snap components 550 are positioned adjacent to the spine 516 and are aligned with each other. Further, the male snap components 550 are aligned with the female snap components 548 on the front panel 512. The male snap components 550 are complementary to the female snap components 548 such that the male snap components 550 may engage the female snap components to engage or interlock panels together.

In operation, the attachable binder 500 may be coupled to another attachable device including complementary snap features. In one example, two attachable binders 500 may be attached to each other. A first attachable binder 500 may be attached to a second attachable binder 500 using the snap features. The male snap components 550 on the rear panel 514 of the first attachable binder 500 may be aligned with the female snap components 548 on the front panel 512 of the second attachable binder 500. Manual pressure may be applied to the female snap components 548 and or the male snap components 550 to interlock the male and female snap pairs together.

It is to be understood that the snap components described herein may be incorporated into any office and/or school devices including but not limited to notebooks, folders, and pouches. In this manner, the snap components described herein may be used to create various attachable devices that may be interchangeably attached or otherwise coupled to each other.

Further, although the female snap components 548 and the front panel 512 includes the male snap components 550 are depicted on the rear panel 514 of the attachable device 500, it is also contemplated that the orientation may be reversed. That is, the female snap components 548 may be included on the rear panel 514 and the male snap components 550 may be included on the front panel 512.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. Further uses of singular terms such as “a,” and “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

The use of any and all examples, or exemplary language (e.g., “such as”) provided herein, is intended to illuminate the disclosure and does not pose a limitation on the scope of the disclosure. Any statement herein as to the nature or benefits of the disclosed device is not intended to be limiting. This invention includes all modifications and equivalents of the subject matter recited herein as permitted by applicable law. Moreover, any combination of the above-described elements in all possible variations thereof is encompassed by the disclosure unless otherwise indicated herein or otherwise clearly contradicted by context. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An attachment system, comprising:
a first component comprising a first panel including:
at least one free edge having a flap that defines a flap opening between the flap and the first panel; and
a swing clip coupled to the first panel adjacent to the flap, the swing clip being moveable between a closed position wherein the swing clip engages the flap and an open position wherein the swing clip does not engage the flap; and
a second component comprising a second panel having at least one free edge with a notch formed therein,
wherein the second component is attachable to the first component in a first configuration wherein the free edge of the second panel is positioned within the flap opening such that the notch is aligned with the flap opening and wherein the swing clip is in the closed position such that the notch and the flap are nested within the swing clip.

2. The attachment system of claim 1, wherein the swing clip is aligned with the at least one free edge of the first panel in the closed position, and wherein the swing clip is not aligned with the at least one free edge of the first panel in the open position.

3. The attachment system of claim 1, wherein the first panel further includes at least one secured edge that meets the at least one free edge at a first corner of the first component, and wherein the first panel further includes a pocket disposed on an outside surface of the first panel.

4. The attachment system of claim 3, wherein the pocket includes a pocket panel having at least one edge coupled to the first panel opposite the at least one secured edge of the first panel.

5. The attachment system of claim 4, wherein the pocket receives a portion of the second panel in the first configuration.

6. The attachment system of claim 1, wherein the at least one free edge of the first panel aligns with the at least one free edge of the second panel in the first configuration.

7. The attachment system of claim 1, wherein the flap comprises a piece of material that extends from the free edge of the first panel and is folded over a face the first panel to define the flap opening.

8. The attachment system of claim 1, wherein the flap is coupled to the at least one free edge along a crease line.

9. The attachment system of claim 1 wherein the flap is integral with the first panel.

10. The attachment system of claim 1, wherein the swing clip is rotatably coupled to the first panel.

11. The attachment system of claim 1, wherein the first component and the second component comprise one or more of a notebook, a folder, a binder, and a storage pouch, and wherein the first component is different from the second component.

12. The attachment system of claim 1, wherein the first panel is a front panel of the first component, and wherein the second panel is a rear panel of the second component.

13. An attachment system, comprising:
a first component comprising:
a first front panel including at least one free edge having a first flap that defines a first flap opening between the first flap and the first front panel, and a first swing clip coupled to the first front panel adjacent to the first flap, the first swing clip being moveable between a closed position wherein the swing clip swing clip engages the flap and an open position wherein the swing clip does not engage the flap; and
a first back panel including at least one free edge with a first notch formed therein; and
a second component comprising:
a second front panel including at least one free edge having a second flap that defines a second flap opening between the second flap and the second front panel, and a second swing clip coupled to the second front panel adjacent to the second flap, the second swing clip being moveable between a closed position wherein swing clip engages the flap and an open position wherein the swing clip does not engage the flap; and
a second back panel including at least one free edge with second notch formed therein;
wherein the second component is attachable to the first component in a first configuration wherein the at least one free edge of the second back panel is positioned within the first flap opening such that the second notch is aligned with the first flap opening and wherein the first swing clip is in the closed position such that the notch and the first flap are nested within the first swing clip.

14. The attachment system of claim 13, wherein the second component is attachable to the first component in a second configuration wherein the at least one free edge of the first back panel is positioned within the second flap opening such that the first notch is aligned with the second flap opening and wherein the second swing clip is in the closed position such that the first notch and the second flap are nested within the second swing clip.

15. The attachment system of claim 13, further comprising:
a third component comprising including at least one panel having a first free edge with a third notch formed therein,
wherein the third component is attachable to the first component in a third configuration wherein the first free edge of the at least one panel is positioned within the first flap opening such that the third notch is aligned with the first flap opening and wherein the first swing clip is in the closed position such that the third notch and the first flap are nested within the first swing clip.

16. The attachment system of claim 15, wherein the third component is attachable to the second component in a fourth configuration wherein the first free edge of the at least one panel is positioned within the second flap opening such that the third notch is aligned with the second flap opening and wherein the second swing clip is in the closed position such that the third notch and the second flap are nested within the second swing clip.

17. The attachment system of claim 15, wherein the third component further includes a second free edge transverse the first free edge, the second free edge including a third swing clip.

18. The attachment system of claim 15, wherein an inside portion of the first component and the second component include at least one of a sheet of paper, an internal pocket, and a binding mechanism that are accessible in the first configuration.

19. The attachment system of claim 16, wherein the third component includes a pouch that is accessible in the third configuration.

20. A method of attaching at least two components together, at least one component comprising a clip panel including at least one free edge, the free edge having a swing clip coupled thereto and a flap folded over the clip panel, the swing clip being moveable between a closed position wherein the swing clip engages the flap and an open position wherein the swing clip does not engage the flap, and at least one component comprising a notch panel having at least one free edge with a notch formed therein, the method comprising:
inserting the notch panel under the flap of the clip panel such that the notch is aligned with the flap;
moving the swing clip to the closed position such that the flap and at least a portion of the notch panel are nested within the swing clip.

21. The method of claim 20, wherein the clip panel further includes at least one corner pocket, and the method further comprises inserting the notch panel into the at least one corner pocket.

22. The method of claim 20, wherein the at least two components include one or more of a notebook, a folder, a binder, and a storage pouch.

23. An attachment system including at least one component, the at least one component comprising:
a first panel including:
a first free edge, a second free edge, a third free edge, and a secured edge, the first free edge being opposite the third free edge, and the second free edge being opposite the secured edge,
a flap disposed on the first free edge, the flap defining a flap opening between the flap and the first panel,
a swing clip coupled to the first panel along the first free edge adjacent to the flap, the swing clip being moveable between a closed position wherein the swing clip engages the flap and an open position wherein the swing clip does not engage the flap; and
at least one corner pocket disposed at a corner of the first panel where the second free edge and the third free edge meet; and
a second panel including:
at least one free edge with a notch formed therein, the notch being aligned with the swing clip and the flap on the first panel,
wherein a sheet of paper or another component is attachable to the front panel via the flap, the swing clip, and the at least one corner pocket.

24. The attachment system of claim 23, wherein the at least one corner pocket is formed from a pocket panel coupled to the first panel adjacent to at least the second free edge.

25. The attachment system of claim 24, wherein the pocket panel is further coupled to the first panel adjacent to the third free edge.

26. The attachment system of claim 23, wherein a second component is attachable to the at least one component in a configuration wherein at least a portion of the notch of the second panel is disposed within an attachment mechanism of the second component.
